(19) United States
(12) Patent Application Publication
(10) Pub. No.: US 2026/0209004 A1
(43) Pub. Date: Jul. 23, 2026

(54) A CONTROL UNIT FOR AN ELEVATOR CAR

(71) Applicant: INVENTIO AG, Hergiswil (CH)

(72) Inventors: Deepak Varma, Pune (IN); Advitiya Saxena, Pune (IN); Varsha Trivedi, Pune (IN); Jacqueline Walther, Ebikon (CH)

(21) Appl. No.: 19/139,573

(22) PCT Filed: Dec. 13, 2023
(86) PCT No.: PCT/EP2023/085639

§ 371 Date: Jun. 16, 2025

(30) Foreign Application Priority Data
Dec. 23, 2022 (EP) 22216390.9

(51) Int. Cl. B66B 1/46; B66B 1/50; B66B 3/00

(52) U.S. Cl. CPC B66B 1/467; B66B 1/461; B66B 1/50; B66B 3/002

(57) ABSTRACT

A control unit for an elevator car is operable by a passenger and includes a grab handle installed on a wall of the elevator car. The grab handle is adapted to be held by the passenger. The control unit also includes at least one button installed on the grab handle and adapted to be actuated by the passenger, wherein an actuation of the button transmits an instruction to a controller of the elevator car to execute an operation associated with the elevator car based on the instruction. Further, the control unit includes a haptic system that provides predefined haptic feedback to the passenger associated with the elevator car operation.

### FIELD

The invention relates to elevators and more particularly, to a control unit for an elevator car operable by a passenger for providing haptic feedback to the passenger based on the operations of the elevator car.

### BACKGROUND

Generally, an elevator car has a car operating panel that enables a passenger to provide an input to execute an operation on the elevator car. The car operating panel has buttons for being operated by the passengers to give a command, such as a floor call. In addition, the car operating panel may also provide feedback in response to the pressing of the buttons. For instance, the car operating panel includes a display or a speaker unit to provide a visual and aural feedback to the passenger. However, such a car operating panel is difficult to be operated by a passenger with disabilities. For instance, a blind passenger may not be able to operate the car operating panel without any aural feedback. Similarly, a deaf passenger may not be able to operate the car operating panel without any visual feedback.

Some of the elevator cars have additional implements to facilitate passengers with a disability to operate the elevator car and to provide haptic feedback to the passenger corresponding to the arrival of a floor. For example, a Chinese patent publication CN 109987466 A describes an elevator car for a blind person. The elevator car has a car operating panel with buttons having embossed braille text and a grab handle with a vibration motor installed inside the grab handle. In operation, the blind person can input a floor number via the car operating panel and hold the grab handle once the elevator car starts moving. Thereafter, the grab handle can actuate the vibration motor to provide haptic feedback to inform the blind person about the arrival of the inputted floor number.

There are a few limitations associated with the current elevators. For instance, the current elevator car is not capable of providing real-time feedback to the passenger with a disability, so the person with a disability is aware of the operations, such as a door movement and a car movement associated with the elevator car. As a result, such passengers require the assistance of another passenger without any disability to operate the elevator car's operating panel and to know the real-time status of the operations of the elevator car.

Therefore, there is a need for a control unit that enables a passenger with a disability to operate the elevator car and provide feedback as per the actions performed by the elevator car.

### SUMMARY

It is in particular an object of the invention to submit a control unit for an elevator car. The control unit is separate from a car operating panel and is adapted to provide haptic feedback to a passenger regarding the operations associated with the elevator car. According to the present subject matter of the invention, this object is solved by a control unit having the features described herein.

The control unit for an elevator car is disclosed in the present subject matter. The control unit includes a grab handle installed on a wall of the elevator car and adapted to be held by a passenger. The control unit also includes at least one button installed on the grab handle and adapted to be actuated by the passenger. Actuation of the at least one button may transmit an instruction to a controller of the elevator car to execute an operation associated with the elevator car based on the instruction. Further, the control unit includes a haptic system adapted to provide predefined haptic feedback to the passenger associated with the operation.

As mentioned before, the buttons on the grab handle allow the passenger to provide instructions and the haptic unit provides haptic feedback unique to the instructions. Moreover, the haptic feedback is provided in real-time thereby making the passenger aware of the operation associated with the elevator car. The predefined feedback is intuitive to the passenger. Moreover, the control unit acts separately from the car operating panel and can override the instructions from the car operating panel. Moreover, the control unit provides a simpler interface of three buttons or fewer for the passenger to input the instructions.

In an embodiment, the at least one button is adapted to be actuated by pressing the at least one button in a predefined operation pattern from a plurality of predefined operation patterns by the passenger.

Preferably, the predefined feedback is indicative of at least one of an approaching floor number, an upward movement of the elevator car, a downward movement of the elevator car, an opening of an elevator door, and a closing of the elevator door.

Preferably, the at least one button includes a disability button adapted to provide haptic feedback to the passenger as an indication of the number of floors passed by the elevator car and receive an input from the passenger as an indication of stopping the elevator car at a subsequent floor.

Preferably, the at least one button includes a first button adapted to receive an input to select a unit place digit of a number of a destination floor, and a second button adapted to receive an input to select a tenth-place digit of the number of the destination floor.

Preferably, the at least one button includes a first button having a distinctive braille text embossed thereon and adapted to receive an input as a tap on the first button to transmit an instruction to the controller for moving the elevator car in an upward direction, and a second button having another distinctive braille text embossed thereon and adapted to receive the input as a tap on the first button to transmit an instruction to the controller for moving the elevator car in a downward direction. In one example, a number of taps on the first button and the second button indicate a reference number of floors the passenger instructs the elevator car to travel in the upward direction or the downward direction, respectively.

Preferably, the at least one button includes a power button adapted to receive an input to transmit an instruction to the controller to display a floor selection menu on a Car Operating Panel (COP) of the elevator car, a first button adapted to receive input to transmit an instruction to the controller to select a higher floor number in the menu on the COP, and a second button adapted to receive input to transmit an instruction to the controller to select a lower floor number in the menu on the COP. In one example, the controller is adapted to provide at least one of a haptic feedback, an audio feedback, and a visual feedback to the passenger, indicative of the selected floor number.

Preferably, the haptic system includes a haptic motor or a pair of haptic motors installed at a predetermined location within the grab handle and adapted to generate the predefined feedback as a haptic pattern.

The object mentioned above is also solved by an elevator car including a controller and a control unit in communication with the controller and adapted to be installed in a car for being held by a passenger for providing haptic feedback thereto. The control unit includes a grab handle installed on a wall of the elevator car and adapted to be held by the passenger. The control unit also includes at least one button installed on the grab handle and adapted to be actuated in a plurality of predefined patterns by a passenger, each predefined pattern associated with an operation of the elevator car. In one example, the actuation of the at least one button in a predefined pattern transmits an instruction to a controller for performing to execute an operation associated with the associated operation of the elevator car based on the instruction. Further, the control unit includes a haptic system adapted to provide a predefined feedback to the passenger associated with the operation. Further, the predefined feedback is indicative of the performance of the associated operation of the elevator car.

Additional advantages, features, and details of the invention result using the following description of exemplary embodiments and using drawings in which the same or functionally identical elements are provided having identical reference signs.

According to the present subject matter, the term ‘elevator car’ is a compartment that carries people/goods vertically to a floor within a building. Further, the term ‘shaft’ is an enclosed space in which the elevator car travels. The term ‘controller’ is an electronic device that controls the operation of the elevator car. The term ‘grab handle’ is an object that the passenger can hold while sitting or standing in the elevator car. The term ‘haptic motor’ is an electronic device that generates vibration and/or rumbles to provide haptics as a tactile feedback directly to an electronic device. The term ‘haptic system’ is an assembly of haptic motors. The term ‘disability button’ is a button that can be used by a passenger with a disability. The disability button can be used to activate the control unit. The term ‘Car Operating Panel’ (COP) is an interactive device usable by a passenger to operate the elevator car.

To further clarify advantages and features of the present subject matter, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 illustrates a schematic view of an elevator car having a control unit and a grab handle, according to an embodiment of the present subject matter;

FIGS. 2A and 2B illustrate a schematic view of the elevator car with a pair of haptic motors of a haptic system installed underneath a deck of the elevator car, according to an embodiment of the present subject matter;

FIGS. 3A and 3B illustrate a schematic view of the elevator car with two pairs of haptic motors of the haptic system installed underneath the deck of the elevator car, according to an embodiment of the present subject matter;

FIG. 4 illustrates a schematic view of a grab handle with the haptic system installed therein, according to an embodiment of the present subject matter;

FIG. 5 illustrates a schematic view of another type of grab handle with a single button, according to an embodiment of the present subject matter;

FIG. 6 illustrates a schematic view of a grab handle with a single button, according to another embodiment of the present subject matter

FIG. 7 illustrates a schematic view of a grab handle with two buttons to input a unit place of the floor number and a tenth place of the floor number, according to another embodiment of the present subject matter;

FIG. 8 illustrates a schematic view of a grab handle with two buttons to input increment and decrement the floor number, according to another embodiment of the present subject matter;

FIG. 9 illustrates a schematic view of a grab handle with three buttons, according to another embodiment of the present subject matter; and

FIG. 10 illustrates a method for operating an elevator car, according to an embodiment of the present subject matter.

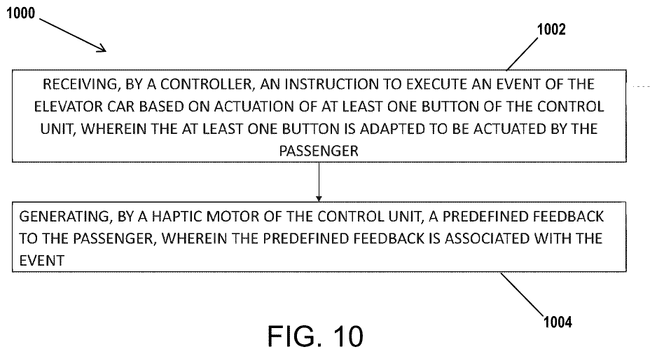

### DETAILED DESCRIPTION

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present subject matter so as not to obscure the drawings with details that will be readily apparent to those of ordinary skill in the art having the benefit of the description herein.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

Any particular and all details set forth herein are used in the context of some embodiments and therefore should not be necessarily taken as limiting factors to the attached claims. The attached claims and their legal equivalents can be realized in the context of embodiments other than the ones used as illustrative examples in the description below.

Embodiments of the present subject matter will be described below in detail with reference to the accompanying drawings.

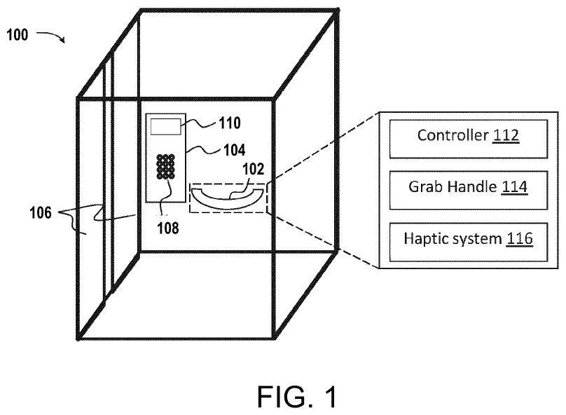

FIG. 1 illustrates a schematic view of an elevator car 100 having a control unit 102, according to an embodiment of the present subject matter. The elevator car 100 is designed to be operated by a passenger, including passengers with a disability. The elevator car 100 can be deployed in a multi-story building and may include a car operating panel (COP) 104 that allows a passenger to provide an input to operate the elevator car 100 via a keypad or a touchpad 108. The input may include, but is not limited to, a selection of the floor, control of the light/fan installed in the elevator car 100, or opening/closing of an elevator door 106. The COP 104 also includes a display unit 110 that displays information, such as the selected floor, the floor passed by the elevator car 100, and the direction of travel to the passenger.

Further, the control unit 102 enables the passenger with a disability to control the elevator car 100 by providing a separate panel from the COP 104. As a result, the passenger without a disability may use the COP 104 to operate the elevator car 100 whereas the control unit 102 can be used by the passenger with a disability to operate the elevator car 100. Further, the control unit 102 is designed to prevent inadvertent actuation by a passenger without a disability, details of which will be explained later.

According to the present invention, the control unit 102 provides a predefined feedback for each operation of the elevator car 100. The predefined feedback is indicative of the operation that may be at least one of an approaching floor number, an upward movement of the elevator car, a downward movement of the elevator car, an opening of the elevator door 106, and a closing of the elevator door 106. Moreover, the predefined feedback enables the passenger with a disability to accurately determine the operation associated with the elevator car 100. For instance, the predefined feedback may be in a form of short pulses or maybe in a form of a waveform.

In one example, the control unit 102 is installed on a wall of the elevator car 100. The control unit 102 may be installed at an elevation lower than an elevation of the COP 104 to make it accessible to the passenger. The control unit 102 may include a grab handle 114 and a haptic system 116. The grab handle 114 may be adapted to be held by the passenger and, may receive inputs from the passenger to execute the operation associated with the elevator car 100. The haptic system 116 is configured to provide a feedback to the passenger.

The haptic system 116 may include a plurality of haptic motors (not shown). A haptic motor could be a tiny vibration motor used in a mobile device like a mobile telephone, an eccentric rotating mass (ERM) motor, a linear resonant actuator (LRA), etc. In an embodiment, the haptic system 116 may be configured as a single haptic motor, a haptic motor or a pair of haptic motors, or multiple pairs of haptic motors. The number of haptic motors may depend on various factors, such as the size of the elevator car 100, the size of the grab handle 114, and a type of predefined feedback. The haptic system 116 is installed at different positions in the elevator car 100. In one example, the haptic system is either built in the grab handle 114 or in the elevator car 100. Details of such exemplary embodiments are explained later.

In one example, the control unit 102 may include a controller 112 that is adapted to operate the elevator car 100 based on the inputs from either the COP 104 or the control unit 102 or both. The controller 112 may be a programmable logic controller 112 and may control motors that power a cable and pulley mechanism to move the elevator car 100 in an elevator shaft. In another example, the controller 112 may be external to the control unit 102. Further, the controller 112 may be coupled to a memory module having a repository to store information about the operation and the associated feedback to be generated via the haptic system 116. In one example, the controller 112 may access the repository to determine the predefined feedback to be provided to the passenger.

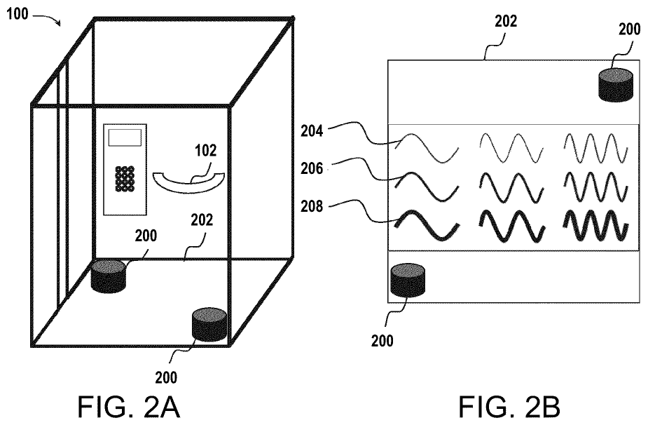

FIG. 2A illustrates a schematic view of the elevator car 100 with a pair of haptic motors 200 of the haptic system 116 installed underneath the floor of the elevator car 100, according to an embodiment of the present subject matter. The pair of haptic motors 200 are installed underneath a deck 202 of the elevator car 100. In the illustrated embodiment, the haptic motors 200 are installed at diagonally opposite corners of the deck 202. However, the haptic motors 200 can be positioned at different locations underneath the floor of the elevator car 100. In an example, the haptic motors 200 are adapted to generate the predefined feedback as a haptic pattern as shown in FIG. 2B. The haptic pattern can be in a form of plurality of waves 204, 206, and 208 on the deck 202, such that each wave indicates each operation associated with the elevator car 100. In one example, one of the haptic wave 204 indicates the travelling of elevator car 100 in the upward direction, whereas another haptic wave 206 indicates the travelling of the elevator car 100 in the downward direction. Further, the haptic wave 208 indicates the arrival of the elevator car 100 to different floors in the building.

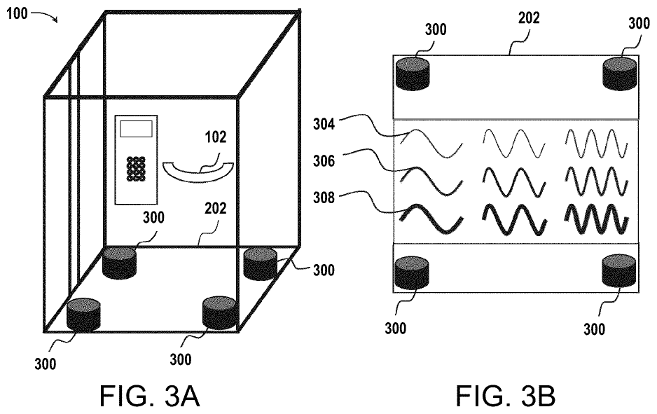

A number of the haptic motors 200 deployed in the haptic system 116 may be varied to achieve a pre-set resolution, an intensity, and a number of unique predefined feedbacks. In an embodiment, the haptic system 116 may also have multiple pairs of haptic motors. An exemplary embodiment of such a setup is shown in FIGS. 3A and 3B. FIG. 3A illustrates a schematic view of the elevator car 100 with two pairs of haptic motors 300 of the haptic system 116 installed underneath the deck 202 of the elevator car 100. In such a setup, the haptic motor 300 is placed underneath the deck and positioned at each corner of the deck 202 to generate a plurality of haptic waves 304, 306, and 308 shown in FIG. 3B. In an embodiment, the haptic waves 304, 306, and 308 may be the same as the haptic waves 204, 206, and 208 shown in FIG. 2B. As may be understood, the presence of a total of four haptic motors 200 allows the control unit 102 to increase the resolution, intensity, and the number of unique predefined feedbacks.

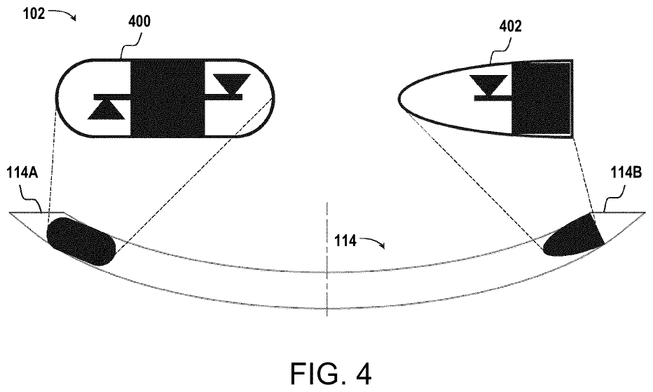

While the foregoing description illustrates the positioning of the haptic motors, such as 200, and 300, external from the grab handle 114, the haptic motors, such as 200, and 300 may be installed within the grab handle 114. Such exemplary embodiments are explained with respect to FIG. 4. Specifically, FIG. 4 shows a grab handle 114 having a pair of haptic motors 400 and 402, according to an embodiment of the present subject matter. In the illustrated embodiment, the haptic motors 400 and 402 are installed at the ends 114A and 114B of the grab handle 114. In one example, the haptic motor 400 may include a dual mass ERM whereas the haptic motor 402 is a single mass ERM. Further, the haptic motors 400 and 402 work synergistically to generate the predefined feedback associated with the operation of the elevator car 100 (shown in FIG. 1).

In one example, the grab handle 114 may be installed vertically in the elevator car 100 and the haptic motors 400 and 402 generate the predefined feedback which is intuitive to the passenger holding the grab handle 114. For example, in case the elevator car 100 is travelling in the upward direction, the haptic motor 402 may start vibrating and gradually increases its intensity. Subsequently, the haptic motor 400 starts vibrating and thereby, creating a wave of vibration to be sensed by the passenger. Further, the wave of vibration travels from the bottom to the top of the grab handle 114 and thereby, imitating the upward movement of the elevator car 100. Conversely, the haptic motors 400 and 402 generate a wave of vibrations that travels from the top to the bottom of the grab handle 114 and thereby, imitating the downward travel of the elevator car 100.

In another example, the haptic motors 400 and 402 may operate either simultaneously or sequentially to generate a number of pulses of vibrations corresponding to the floor that the elevator car 100 has passed during its movement. In such an example, if the elevator car 100 moves from a second floor to a fourth floor of the building, then the haptic motors 400, and 402 may operate simultaneously or sequentially to generate three pulses when the elevator car 100 reaches the third floor and four pulses when the elevator car 100 reaches the fourth floor. While the present illustration shows a pair of haptic motors 400, 402, the number of haptic motors may vary depending upon the size of the grab handle 114, and the number of predefined feedbacks that the control unit 102 (shown in FIG. 1) can deliver.

According to the present invention, the grab handle 114 of the control unit 102 may have different configurations. For instance, the control unit 102 can have one or more buttons that are adapted to be actuated by the passenger to transmit an instruction to the controller 112 for executing the operation associated with the elevator car 100. The button may be pressed for a predefined operation pattern from a plurality of predefined operation patterns to be actuated by the passenger. The predefined operation patterns may be embodied as, but are not limited to, a number of taps/presses on the button.

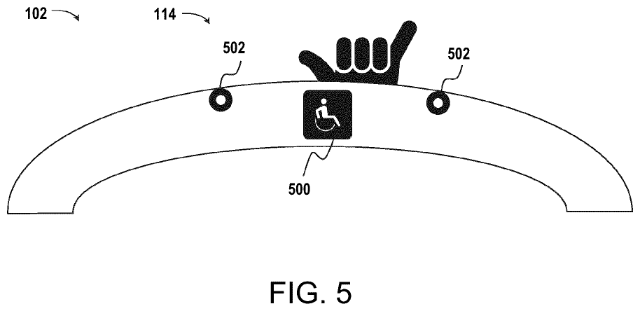

The control unit 102 may have either a single button or multiple buttons to receive instructions to operate the elevator car 100. Exemplary embodiments are illustrated in FIG. 5 onwards.

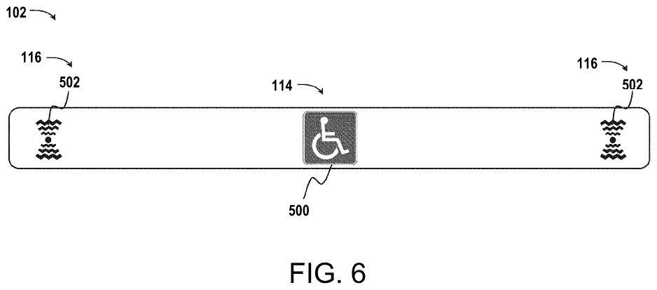

FIG. 5 illustrates a schematic view of the grab handle 114 with a single button 500 and FIG. 6 illustrates a schematic view of another type of grab handle 114 with a single button 500. Referring to FIG. 5, in the illustrated embodiment, the button 500 is adapted to be actuated to provide input to the controller 112. The button 500 may be placed at the center of the grab handle 114 and a pair of haptic motors 502 of the haptic system 116.

Referring to FIG. 6, in the illustrated embodiment, the haptic motor 502 may also be placed at the corners of the grab handle 114. In both the illustrated embodiments, the button 500 is installed in the middle of the grab handle 114. In an example, the button 500 may be placed ergonomically at an inward part of a portion of the grab handle 114 grabbed by the passenger, such that the button 500 may be easily accessed.

In an example, the button 500 may be a disability button 500 having a disability symbol. The disability symbol indicates to the passengers without disabilities that the disability button 500 is dedicated for use by the passenger having a disability. As mentioned earlier, the control unit 102 is configured in such a manner that the control unit 102 prevents its inadvertent actuation. In an example, the control unit 102 remains inactivated unless the passenger activates the control unit 102.

The control unit 102 may be activated by using the disability button 500 which is adapted to receive an input, from the passenger, indicative of the activation of the haptic system 116 by the controller 112. In one embodiment, the input may be pressing the disability button 500 for a predefined time. For example, if the passenger presses the disability button 500 for a predefined time, such as 5 seconds, then the control unit 102 may be activated to provide haptic feedback to the passenger and to receive inputs to operate the elevator car 100. This eliminates inadvertent activation of the control unit 102 by other passengers in the elevator car 100.

In another embodiment, the input may be a pre-set number of taps on the disability button 500. For example, if the passenger presses the disability button 500 for three times, then the control unit 102 may be activated to provide haptic feedback to the passenger and to receive further inputs to operate the elevator car 100. This also eliminates inadvertent activation of the control unit 102 by other passengers in the elevator car 100.

In yet another embodiment, the grab handle 114 and the disability button 500 may include a capacitive touchpad that the passenger can interact with to activate the haptic system 116 and to provide inputs for operating the elevator car 100. For example, the passenger may touch and swipe the grab handle 114 to provide the input to activate the control unit 102.

In yet another embodiment, the button 500 may include a pressure sensor that may sense the pressure applied to the disability button 500. In such an embodiment, if the pressure sensed is greater than a predefined pressure, then the control unit 102 may be activated to provide haptic feedback and to operate the elevator car 100. Further, based on the pressure sensed, the controller 112 may be configured to determine a set of traits, such as age, associated with the passenger.

In either of the aforementioned embodiments, the input may be sent to the controller 112, and based on the input, the controller 112 may activate the haptic system 116 (shown in FIG. 1) to provide the predefined feedback. Moreover, the receipt of the input is interpreted by the controller 112 to activate the haptic system 116 and starts responding to the subsequent instructions from the disability button 500.

Once activated, the controller 112 may receive the instructions from the disability button 500. Further, the disability button 500 receives input from the passenger which is indicative of the destination floor that the passenger wants to arrive at. In an example, the input may be the number of taps performed by the passenger on the disability button 500 indicating a reference number of the destination floor. In such an example, each tap on the disability button 500 may be followed by predefined feedback corresponding to the floor to be selected. For example, the passenger taps the disability button 500 for five times indicating the destination floor, i.e., the fifth floor. Then, after each tap of the disability button 500, the passenger may receive predefined feedback, such as vibration with different wavy patterns, indicating the number of the floor corresponding to the respective tap of the disability button 500.

In an example, a first tap may indicate the selection of a ground floor of the building and subsequent taps increment the floor count by one. For example, the passenger taps the disability button 500 for five times indicating the destination floor, i.e., the fourth floor.

During the operation, once the input is received, the controller 112 may wait to check if the passenger has released the disability button 500. Release of the disability button 500 is determined as the completion of inputting the instruction. Based on the received inputs, the controller 112 may actuate electric motors that power the cable and pulley mechanism to move the elevator car 100 to the destination floor. In addition, the haptic motors 502 may also provide predefined feedback to the passenger via the grab handle 114 for the confirmation of the selection of the selected floor. Further, as the elevator car 100 travels through different floors, the controller 112 actuates the haptic motors 502 to provide predefined feedback in the form of wavy patterns as explained with respect to FIGS. 2A, 2B, 3A and 3B.

In addition to inputting the instruction, the disability button 500 may be actuated by the passenger to change the mode of receiving the predefined feedback. In one example, the disability button 500 may receive a one-tap input from the passenger to enable audio predefined feedback. For instance, a blind passenger may operate the disability button 500 by providing the one-tap input to enable the audio predefined feedback. In another example, the disability button 500 may receive a two-tap input from the passenger to enable the haptic feedback. For instance, a deaf passenger or a blind passenger may operate the disability button 500 by providing the two-tap input to enable haptic feedback. In yet another example, the disability button 500 may receive a triple-tap input from the passenger to enable a combination of the audio predefined feedback and the haptic feedback. During the movement of the elevator car 100, the passenger may keep on holding the grab handle 114 and pressing the disability button 500 when the elevator car 100 is travelling.

Further, the haptic system 116 generates the predefined feedback which is provided by the grab handle 114 and the disability button 500 as the number of floors are passed by the elevator car 100. The predefined feedback allows the passenger to count the floors passed. Further, as the destination floor approaches, the passenger may press the disability button 500 to provide the input indicative of stopping the elevator car at the subsequent floor, which in one example, is the destination floor. In another example, the passenger may release the pressed disability button 500 which is interpreted as the input to stop the elevator car 100 at the subsequent floor.

During the operation, the passenger with a disability may enter the elevator car 100 and approaches the grab handle 114. Thereafter, the passenger presses the disability button 500 to activate the haptic system 116. Once activated, the passenger may input the destination floor number in the manner explained earlier. Once the destination floor number is inputted to the controller 112, the controller 112 may actuate electric motors that power the cable and pulley mechanism to move the elevator car 100 to the destination floor. Further, as the elevator car 100 travels through the floors, the haptic system 116 generates a number of predefined feedbacks in real-time for the passenger. In one example, the haptic system 116 generates a haptic wave that travels downward to upward to imitate the movement of the elevator car 100. Further, the haptic system 116 generates another predefined feedback corresponding to the arrival of the destination floor. Furthermore, the haptic system 116 generates another predefined feedback when the elevator car 100 parks at the destination floor to intimate the passenger that the elevator door 106 is opened and the passenger can deboard.

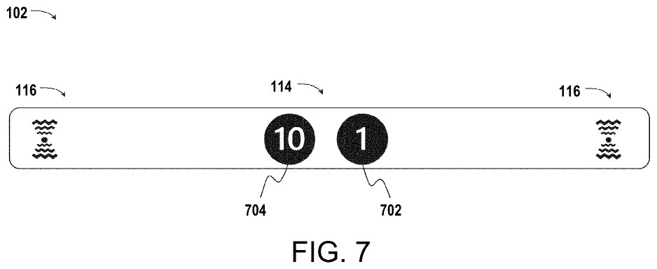

According to the present invention, the control unit 102 may have two buttons to input the instruction. Such an exemplary embodiment is explained with respect to FIG. 7. Specifically, FIG. 7 illustrates a schematic view of the grab handle 114 with two buttons to input a unit place of the floor number and a tenth place of the floor number, according to an embodiment of the present subject matter. In the illustrated embodiment, one of the buttons is a first button 702 and another button is a second button 704. Further, either of the first button 702 and the second button 704 may act as a disability button and may function like the disability button 500 as explained with respect to FIGS. 5 and 6.

In an example, the first button 702 is adapted to receive an input to select a unit place digit of a number of a destination floor. Further, the second button 704 is adapted to receive input to select a tenth-place digit of the number of the destination floor. For example, if the passenger wants to travel to the destination floor, i.e., the 12th floor, then the first button 702 may be pressed two times to select digit ‘2’and the second button 704 may be pressed one time to select digit ‘1’.

Although not shown, the grab handle 114 may include a haptic motor similar to the haptic motors explained earlier with respect to FIGS. 2A through 4.

During the operation, the passenger may activate the control unit 102 by pressing either of the first button 702 and the second button 704 in a manner that the passenger would operate the disability button 500 explained earlier with respect to FIG. 5. Once activated, the passenger may press the first button 702 to input the unit place digit of the destination floor. For instance, the passenger may tap the first button 702 to select the unit place digit of the destination floor. Further, for each tap, the haptic system 116 may generate predefined feedback indicative of the current number for the unit place digit. Thereafter, the passenger may tap the second button 704 to select the tenth-place digit of the destination floor. Hereto, for each tap, the haptic system 116 may generate predefined feedback indicative of the current number for the tenth-place digit.

Once the destination floor is selected, the passenger stops pressing the second button 704. Further, the controller 112 checks for the non-receipt of additional taps on the second button 704 after a predefined time interval. The lapse of non-receipt of the input after a predefined time interval is interpreted by the controller 112 as an instruction for the destination floor selection. Subsequently, the controller 112 actuates the haptic system 116 to provide the predefined feedback to the passenger corresponding to the selection of the destination floor.

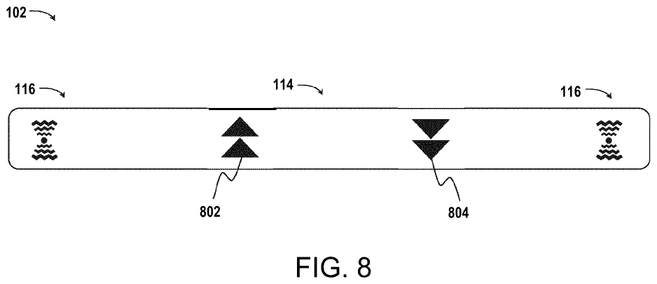

According to an embodiment, the buttons on the grab handle 114 may input the direction of travel of the elevator car 100. Such an exemplary embodiment is explained with respect to FIG. 8 which illustrates a schematic view of the grab handle 114 with two buttons 802 and 804 to input increment and decrement the floor number, according to an embodiment of the present subject matter. In the illustrated example, the first button 802 is adapted to receive input from the passenger as a tap on the first button 802. The tap on the first button 802 transmits an instruction to the controller 112 for moving the elevator car 100 in an upward direction. Further, the second button 804 is adapted to receive the input as a tap on the second button 804 to transmit another instruction to the controller 112 for moving the elevator car 100 in the downward direction. In other words, the number of taps indicates the reference number of floors the passenger instructs the elevator car 100 to travel in the upward direction or the downward direction, respectively.

Furthermore, the number of taps on the first button 802 indicates a reference number of the floor the passenger instructs the elevator car 100 to travel in the upward direction. Similarly, the number of taps on the second button 804 indicates a reference number of the floor the passenger instructs the elevator car 100 to travel in the downward direction. For example, if the passenger wants to travel to a sixth floor from a second floor, then the first button 802 may be pressed four times by the passenger. Similarly, if the passenger wants to travel to a third floor from the sixth floor, the second button 804 may be pressed three times by the passenger.

In an example, the first button 802 and the second button 804 may have distinctive braille text embossed thereon to enable blind passengers to understand the type of button.

In an example, the first button 802 is adapted to be pressed for a predefined time duration to transmit an instruction to the controller 112 to start moving the elevator car 100 to the top floor. On the other hand, the second button 804 is adapted to being pressed for the predefined time duration to transmit an instruction to the controller 112 to start moving the elevator car 100 to the bottom floor. In an example, the predefined time duration is five seconds. Such a provision allows the passenger to select either the top floor or the bottom floor without multiple tapping the first button 802 or the second button 804.

During the operation, the passenger may hold the grab handle 114 and operates either the first button 802 or the second button 804 as the disability button to activate the control unit 102. A manner in which the disability button is used is already explained with respect to FIG. 5 and hence not repeated for sake of clarity and brevity. Once the control unit 102 is activated using the disability button, such as one of 802, and 804, then the passenger may tap the first button 802 a number of times to provide an input indicative of the number of floors the elevator car 100 should travel in the upward direction. In an example, the passenger may tap the first button 802 for five times to instruct the elevator car 100 to travel to the fifth floor in an upward direction. On the other hand, the passenger may tap the second button 804 a number of times to provide an input indicative of the number of floors on which the elevator car 100 may travel in the downward direction. In an example, the passenger may tap the first button 802 five times to instruct the elevator car 100 to travel five floors in a downward direction.

Upon receipt of the input, the controller 112 waits for the lapse of the predefined time interval for the non-receipt of any further input from the last received input. The lapse of the predefined time interval is interpreted by the controller 112 as the instruction for the selection of the destination floor. Consequently, the haptic system 116 is actuated by the controller 112 to provide the predefined feedback corresponding to the selection of the destination floor to the passenger via the grab handle 114. Further, once the destination floor has arrived, the haptic system 116 provides another predefined feedback corresponding to the arrival at the destination floor.

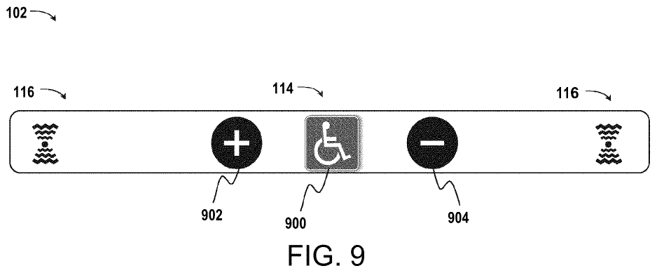

According to an embodiment of the present subject matter, the grab handle 114 can have a three-button configuration. Such an exemplary embodiment is explained with respect to FIG. 9. Specifically, FIG. 9 illustrates a schematic view of the grab handle 114 with three buttons 900, 902, and 904, according to an embodiment of the present subject matter. The three buttons 900, 902, and 904 include a power button 900, a first button 902, and a second button 904. Further, the power button 900 is adapted to receive the input to transmit an instruction to the controller 112 to display a floor selection menu on the COP 104 (shown in FIG. 1) of the elevator car 100. Further, the first button 902 is adapted to receive the input to transmit an instruction to the controller 112 to select a higher floor number in the menu on the COP 104. Furthermore, the second button 904 is adapted to receive an input to transmit an instruction to the controller to select a lower floor number in the menu on the COP 104. The first button 902 and the second button 904 may function similarly to the first button 802 and the second button 804 respectively shown in FIG. 8.

In the illustrated example, the controller 112 is adapted to provide at least one of a predefined haptic feedback, an audio predefined feedback, and a visual predefined feedback to the passenger, indicative of the selected floor number. As may be understood, the controller 112 may actuate the haptic system 116 to provide the predefined feedback whereas the controller 112 may actuate the speaker and the display unit in the COP 104 to provide an audio predefined feedback and a visual predefined feedback to the passenger, respectively.

During the operation, the passenger may operate the power button 900 in order to activate the control unit 102. In an example, the power button 900 may operate the disability button 500 which is explained earlier. A manner of activation of the control unit 102 is already explained earlier with respect to FIG. 5. Once activated, the passenger can input the destination floor by operating the first button 902 and the second button 904 in a manner explained with respect to FIG. 8. Further, each selection of floor is displayed on the COP 104 and an aural response is also provided in addition to the predefined feedback by the haptic system 116. Thereafter, the passenger may again press the power button 900 to confirm the input of the instruction, and accordingly, the controller 112 operates the elevator car 100. The controller 112 also actuates the haptic system 116 to generate the predefined feedback corresponding to the operation of the elevator car 100.

The present subject matter also relates to a method 1000 for operating an elevator car 100. The order in which the method steps are described below is not intended to be construed as a limitation, and any number of the described method steps can be combined in any appropriate order to execute the method or an alternative method. Additionally, individual steps may be deleted from the method without departing from the spirit and scope of the subject matter described herein.

In an example, the method 1000 may be performed partially or completely by the control unit 102 shown in FIG. 1 to FIG. 9. The method begins at step 1002, at which an instruction is received by the controller 112 based on the actuation of the button of the control unit 102 executes the operation of the elevator car 100. Thereafter, at step 1004, the haptic system 116 of the control unit 102 generates the predefined feedback to the passenger. The predefined feedback is associated with the operation of the elevator car 100.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A control unit for an elevator car, the control unit comprising:
a grab handle installed on a wall of the elevator car, the grab handle adapted to be held by a passenger in the elevator car;
at least one button installed on the grab handle, the at least one button adapted to be actuated by the passenger, wherein an actuation of the at least one button transmits an instruction to a controller of the elevator car to execute an operation associated with the elevator car based on the instruction; and
a haptic system installed on the elevator car, the haptic system being activated by the controller to provide a predefined haptic feedback to the passenger associated with the operation.

16. The control unit according to claim 15 wherein the at least one button is actuated by the passenger pressing the at least one button in a predefined operation pattern selected by the passenger from a plurality of predefined operation patterns.

17. The control unit according to claim 15 wherein the predefined feedback is indicative of one of: an approaching floor number; an upward movement of the elevator car; a downward movement of the elevator car; an opening of an elevator door; and a closing of the elevator door.

18. The control unit according to claim 15 wherein the at least one button is a disability button adapted to receive an input from the passenger indicative of a number of a destination floor, the input being a number of taps performed by the passenger on the disability button, the number of taps indicating a reference number of the destination floor.

19. The control unit according to claim 15 wherein the at least one button is a disability button adapted to provide the haptic feedback to the passenger indicating a number of floors passed by the elevator car and to receive an input from the passenger as a command to stop the elevator car at a subsequent floor.

20. The control unit according to claim 15 wherein the at least one button includes a first button adapted to receive an input by the passenger selecting a unit place digit of a number of a destination floor, and a second button adapted to receive another input by the passenger selecting a tenth-place digit of the number of the destination floor.

21. The control unit according to claim 15 wherein the at least one button includes:
a first button having a braille text embossed thereon, the first button adapted to receive an input as a tap by the passenger on the first button and in response to the input transmit an instruction to the controller to move the elevator car in an upward direction;
a second button having another braille text embossed thereon, the second button adapted to receive another input as a tap by the passenger on the second button and in response to the another input transmit another instruction to the controller to move the elevator car in a downward direction; and
wherein a number of the taps on the first button indicates a reference number of floors the passenger instructs the elevator car to travel in the upward direction and a number of the taps on the second button indicates another reference number of floors the passenger instructs the elevator car to travel in the downward direction.

22. The control unit according to claim 21 wherein each of the first button and the second button is adapted to being pressed for a predefined time duration by the passenger to transmit a further instruction to the controller to move the elevator car to a top floor and a bottom floor, respectively.

23. The control unit according to claim 15 wherein the at least one button includes:
a power button adapted to receive an input by the passenger and in response to the input transmit an instruction to the controller to display a floor selection menu on a car operating panel of the elevator car;
a first button adapted to receive another input by the passenger and in response to the another input transmit another instruction to the controller to select a higher floor number in the menu on the car operating panel;
a second button adapted to receive a further input by the passenger and in response to the further input transmit a further instruction to the controller to select a lower floor number in the menu on the car operating panel; and
wherein the controller provides at least one of a haptic feedback, an audio feedback, and a visual feedback for the passenger indicative of the selected floor number.

24. The control unit according to claim 15 wherein the haptic system includes a haptic motor or a pair of haptic motors installed at a predetermined location within the grab handle and generating the predefined haptic feedback as a haptic pattern.

25. A method of operating an elevator car, the method comprising steps of:
providing the control unit according to claim 15 in the elevator car;
receiving, by a controller of the elevator car, an instruction to execute an operation of the elevator car based on an actuation of the at least one button of the control unit by a passenger in the elevator car; and
the controller activating a haptic motor of the control unit to generate a predefined feedback to the passenger, wherein the predefined feedback is associated with the operation.

26. The method according to claim 25 wherein the at least one button is actuated by pressing the at least one button in a predefined pattern selected by the passenger from a plurality of predefined patterns.

27. The method according to claim 25 including receiving, by a disability button of the control unit, an input from the passenger indicative of a number of a destination floor, wherein the input is a number of taps performed by the passenger on the disability button that indicates the number of the destination floor.

28. An elevator car comprising:
a controller;
a control unit in communication with the controller, the control unit installed in the elevator car and providing haptic feedback;
wherein the control unit includes a grab handle installed on a wall of the elevator car and adapted to be held by a passenger;
at least one button installed on the grab handle and adapted to be actuated by the passenger in a plurality of predefined patterns, each of the predefined patterns being associated with a different one of a plurality of operations of the elevator car, wherein the actuation of the at least one button in a selected one of the predefined patterns transmits an instruction to the controller to execute the operation associated with the selected predefined pattern; and
a haptic system adapted to provide a predefined haptic feedback to the passenger associated with the operation being executed, wherein the predefined feedback is indicative of a performance of the operation being executed.
